(19) United States
(12) Patent Application Publication
(10) Pub. No.: US 2011/0011676 A1
(43) Pub. Date: Jan. 20, 2011

(54) Vertical ventilation step

(76) Inventor: Andrew Oscar DeLair, Midland, MI (US)

Correspondence Address: Currie Kendall PLC, 6024 Eastman Ave, Midland, MI, 48640-2518, US

(21) Appl. No.: 12/802,964

(22) Filed: Jun. 17, 2010

Related U.S. Application Data
(60) Provisional application No. 61/270,773, filed on Jul. 14, 2009.

(51) Int. Cl. E06C 7/00

(52) U.S. Cl. 182/129

(57) ABSTRACT

A firefighting roof ladder accessory that is designed to be supported by one rail and at least two rungs of a roof ladder. The accessory comprises a beam having two ends, at one end of said beam is secured a ladder rail box having disposed therein at least two bi-hooks for hooking onto said rungs, and secured to the other end of said beam a foot support, said accessory being designed to be used on a roof ladder having hooks to secure the ladder on the roof during fire fighting activities.

### CROSS REFERENCE TO RELATED APPLICATION

This application claims priority from U.S. Provisional Application Ser. No. 61/270,773, filed Jul. 14, 2009, by Andrew O. DeLair entitled Vertical Ventilation Step. The specification and drawings are specifically incorporated herein by reference.

### BACKGROUND OF THE INVENTION

Ventilation is the systematic removal of smoke and heated fire gases from a burning structure. Ventilation is performed in four basic situations. These situations include fire control, fire attack, rescue and overhaul. Firefighters have a choice of basic ventilation types to accomplish the objectives of these situations. The basic types are vertical, horizontal, and forced ventilation. The focus of this invention is vertical ventilation.

Vertical ventilation is the process of allowing heat and smoke to travel upwards and out of a structure. This is performed by cutting vents or making use of existing openings in the roof of the structure. To accomplish vertical ventilation effectively requires a large number of resources. At a minimum, these resources include two well-trained and fully protected firefighters, cutting equipment, ladders, and a charged line. Once these resources have been assembled and moved to the roof, vertical ventilation normally involves first opening existing openings and then making roof cuts as close as safely possible to the seat of the fire. Firefighters making roof cuts know that one large vent is more effective than several small vents and once vertical ventilation is completed, return immediately to the safety of the ground.

The advantage to vertical ventilation is found in basic fire behavior. Due to convection, the first choice of heat is to travel straight up. Vertical ventilation allows this natural movement to occur and is, consequently, the most effective form of ventilation. When vertical ventilation is properly performed, it can greatly reduce the mushrooming of gases and improve the conditions inside the structure. Unfortunately, there are a number of disadvantages to vertical ventilation. First, firefighters are subjected to all the dangers of being on the roof of a structure. These include structural collapse, disorientation, and falls. Second, vertical ventilation takes time to perform and is often impractical. Many roofs are extremely difficult to breach and fires not on the top floor may see little benefit to the operation. Third, as described above, vertical ventilation demands a large number of resources. Most departments do not initially have the firefighters necessary to perform vertical ventilation in the early stages of an incident. Even though these disadvantages exist, there are times when vertical ventilation is preferred.

When departments have adequate personnel, vertical ventilation and other operations can be performed simultaneously. Departments that do not have these resources must still recognize when vertical ventilation can assist the operation. Of the four situations discussed, fire control is most effectively accomplished with vertical ventilation. Fire attack, rescue, and overhaul have other ventilation options that departments with limited personnel can perform. The objective of fire control is to stop the horizontal spread of the fire and vertical ventilation makes this possible. This is especially true with attic fires and fires in balloon construction.

Although it will often be too dangerous to vent an attic fire, fires in balloon construction can benefit from early vertical ventilation. Fires that have penetrated into the walls of such structures will quickly travel to the attic. From there, the fire will rapidly spread throughout the structure. If vertical vents have been placed early, before the fire has weakened the roof, the effects of fire spread will be reduced.

The device of this invention is a step that is easily attached to a roof ladder making the creation of vertical ventilation easier and safer. Specifically, the invention is to be used in aiding firefighters cut holes in the roofs of burning buildings to provide ventilation as described hereinbefore. In conventional firefighting procedure, where the roof of a building is exposed to the fire, it is necessary to open a hole in the roof so that the smoke and flame will be concentrated there rather than weakening the entire roof. This also creates an updraft that has a tendency to clear the windows and doors of smoke so that the firefighter may evacuate persons trapped in the building and may themselves enter the building to fight the fire.

In making such an opening it has been the practice to use a single roof ladder that is hooked over the ridge of the roof. The firefighter must then lean over and chop or cut a hole near the side of the ladder. This is a very awkward and dangerous procedure. He may have to leave one foot on the ladder and put one foot on the roof. Sometimes the fire fighter will drive the pick end of his axe into the roof to provide a support for one of his feet. This is unsafe and the fire fighter may need his axe.

In another technique the firefighter may be assisted by a second fire fighter who uses a Halligan/Trash tool or hook to enable the fighter cutting the hole to brace one of his feet. These tools need to be embedded into the roof while the present invention does not. As an improvement to this method the apparatus of U.S. Pat. No. 4,901,818 has been suggested. However this requires the use of two ladders and a large cumbersome platform suspended between the two ladders. It is often the case that there is not sufficient room to place two ladders and not a sufficient number of firemen to place the ladders and the platform.

By use of a unique and simple design the ladder step accessory of the present invention may be used with a conventional ladder to form a safe support for the second foot of the fireman. The invention improves the process of cutting a hole in the roof.

Several devices have been suggested which support either a step or a scaffold from one or more ladders. U.S. Pat. No. 4,279,327 (Warren) and U.S. Pat. No. 4,531,613 (Keigher) are two patents that relate specifically to firefighting but show a in which a single ladder has an extension at the top that is wide enough to embrace the area where the hole is to be made. These two patents show devices that limit the firefighter to the area where the ladder has been hooked and place him/her directly over the cut to be made in the roof Moreover they are cumbersome and require that the attachment be made in essence a part of the ladder. This then requires additional large equipment to be carried by the fire truck. In Design Patent No. 365,156 a foot holder is suggested that requires the use of a pen to attach an arm that is not braced. This can be a very cumbersome and difficult for a fireman to attach to a ladder.

### SUMMARY OF THE INVENTION

The device of the present invention is an accessory, i.e. a step, that is fitted to a standard roof ladder enabling firefighters in cutting a hole in a roof by increasing the amount of support that they have and minimizing the potential danger should the roof weaken underneath them by giving the firefighter a secure step or foothold.

A step or foot support is provided at the end of a beam that, at its other end, is securely affixed to a ladder engaging shaped rail box that fits fairly close over the standard size rail of a fire fighting ladder and securely hooks onto at least two of the rungs of the ladder. The hooks formed in the rail box, called bi-hooks herein, permit the step to be securely fixed onto either rail of the ladder and to extend to either the left or right side of the ladder. The bi-hooks at the lower edge of each outer side of the rail box have an opening that just tightly receives a ladder rung of standard size. The sheet material of which the hook is formed is narrow enough so that it will hook between the ladder rung and the roof regardless of the spacing of the ladder rung from the edge of the side beam of the ladder. Ladder side rails have several standard dimensions so preferably the rail box is sufficiently wide to be useable on all standard ladders.

A brace is preferably secured on the beam and rail box to strengthen the step. The brace can also function as a hand hole to enable the step to be carried by one firefighter.

The device of the instant invention is designed to be used when the ladders of a firefighter are hung over the peak or ridge of a roof in order for a firefighter to ventilate that roof.

### DESCRIPTION OF THE DRAWINGS

FIG. 1 is a tilted side elevation perspective view of the step showing a boxed in foot support 13b.

FIG. 2 is an exploded view of the step.

FIG. 3 is a perspective view of the step shown attached to a standard fire fighting ladder located on a roof.

FIG. 4 is a partial side view of the step showing the detail of how the rungs of a ladder engage the bi-hooks located in the rail box of the invention.

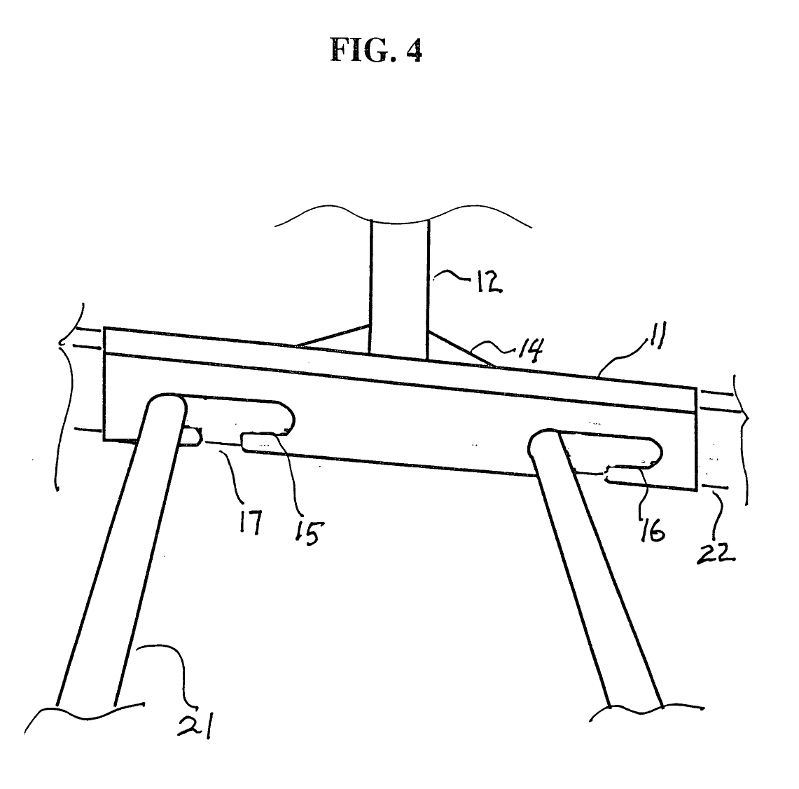

### DETAILED DESCRIPTION OF THE INVENTION

The ladder step accessory 10 is comprised of a ladder rail box 11, a strong rectangular or square shaped, preferably hollow beam, 12, a foot support 13, 13a or as an alternative embodiment a boxed in foot support 13b, and a brace 14.

As disclosed in the FIGS. The ladder rail box 11, have two bi-hooks 15 and 16 which allow the box 11 to be attached to two rungs 21 of a standard ladder 20. The bi-hooks permit the step to be attached onto and extend outwardly from either the right or left rail, 22, of the ladder thus increasing the usefulness of the step. The rail box 11 is of such width that it can be placed over a wide variety of ladders 20 despite those ladders having different sizes of ladder side rails 22. The bi-hooks 15 and 16 of the rail box 11 are accessed by a slot 17, formed in the rail box and are spaced apart thereby allowing each hook 15 and 16 to attach to any two adjacent rungs of a standard ladder on either the left or right ladder rail. The distance of each hook from the bottom of the rail box is preferably set so that the rail box and the beam both essentially sit on the supporting roof upon which the ladder is laying. Most importantly however the distance of the bi hooks from the bottom of the rail box should not exceed the dept of the rail 22 so as to raise the ladder rail off of the surface of the roof.

The brace 14 in the embodiment shown in the drawings is a rectangular plate having a hand holes 23 and 24 formed in the brace on each side of the beam. The hand hole 23 or 24, allows a firefighter to easily carry the step 10 up to the point where it can be used. The hole is large enough to allow for a hand to pass through it but it is not large enough to allow the foot of a fireman standing on the foot supportl 3, 13a or 13b and or the beam to pass through. Other bracing techniques may be employed such by affixing angle or tubular supports between the beam and the rail box. In this latter embodiment the fire fighter may hold onto one of the braces to carry the step.

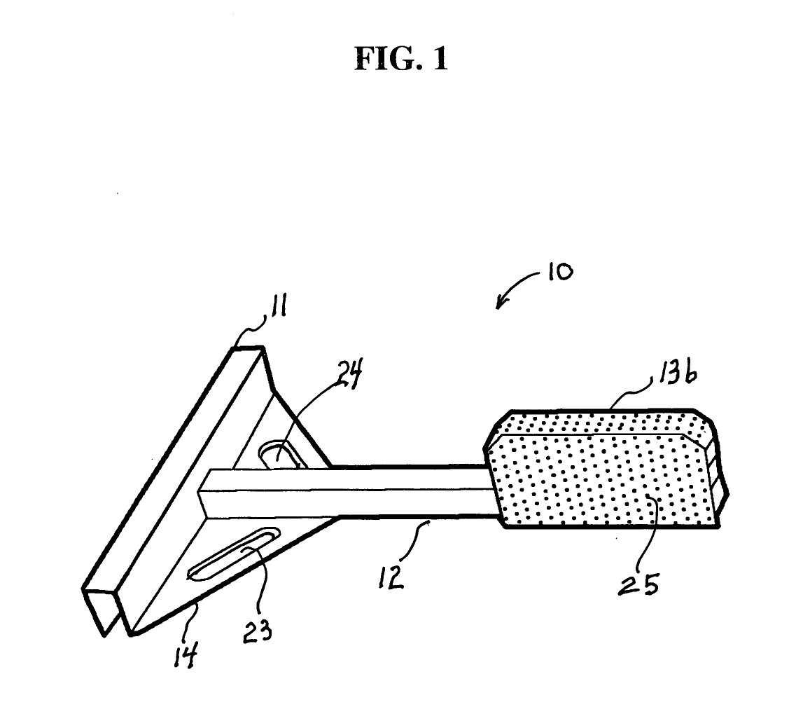

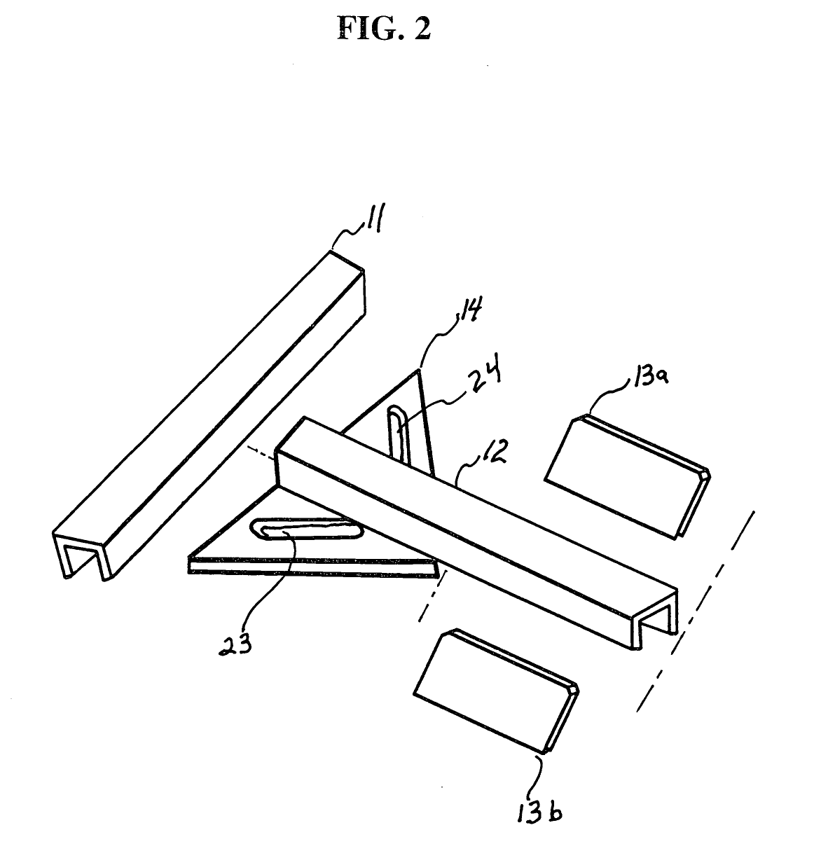

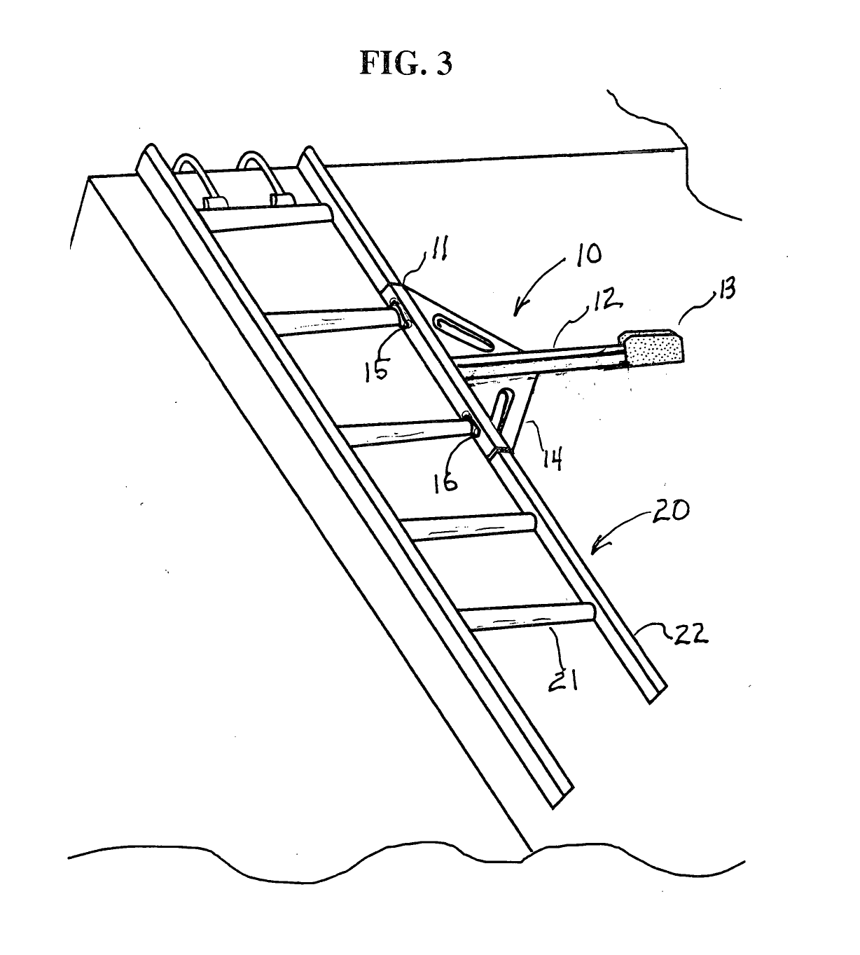

The foot support shown in the embodiment of the invention of the Figures extends higher than the beaml2. The beam 12 preferably lies flat on the surface of the roof. In FIGS. 2 and 3 the foot support is formed of two plates 13 and 13a that are attached to either side of the beam. Thus when the step is positioned on either side of the ladder there is provided adequate support for the fire fighter's foot. In FIG. 1 the foot support 13b is shown as a boxed-in support. This embodiment adds additional strength to the foot support.

When the step 10 is attached to a ladder 20 that is hung from the peak or edge of the roof as shown in FIG. 3 the lower surface of the beam 12 rests on the surface of the roof and the sides of the beam 12 and foot support 13, 13a and 13b are perpendicular to the surface of the roof. The beam extends essentially perpendicularly out from the ladder rail. This allows a firefighter to have a firm place of support upon which to brace himself when he is ventilating a roof no matter what the angle of that roof may be.

The step 10 is preferably made of metal, In one embodiment the step is constructed of three sixteenth inch or one quarter inch thick 6000 series extruded aluminum and the parts welded together to provide a stiff and secure step. Readily available stock aluminum shapes can be used to manufacture the step. The thickness of the construction materials can vary and is sufficient to provide a stiff rigid construction that will not bend or break under normal use. Other techniques of fastening the various parts together can be employed such as bolt and nut, arc welding, spot welding and the like.

The FIGS. also show that the surfaces of foot supports 13, 13a and 13b are covered with non-skid elements 25. The elements 25 reduce the chance that a firefighter or other person who is using invention to rest his or her foot could slip; thereby increasing their safety when using the unit 10. Extruded aluminum sheet have a plurality of perforated buttons such as sold under the trademark “TRACTION TREAD” can be used. The beam can also be provided with a non skid surface.

For the purpose of the following claims a roof ladder is a standard fire fighting or other ladder and can be provided with grappling means which allows the ladder to be easily hung from the ridge of a roof. Standard grappling means as known in the art can be used as well as standard ladders made for use in fighting fires or other uses.

### EXAMPLE

A specific embodiment of the invention was prepared in the following manner. The metal used to construct the step was made from extruded aluminum in the shape of a “U” shaped channel, a square extruded hollow aluminum tube, flat extruded sheet, including a piece of TRACTION TREAD sheet aluminum. The ladder rail box, 11, was made from the channel piece. It measured 24 inches long 2 inches wide and 3.25 inches deep. Two bi-hooks 15 and 16 were cut into one side wall having a distance of 14 inches from center to center line of the bi-hooks. The bi-hooks measured 4.5 inches long by 1.5 inches wide and were positioned 0.75 inch from the bottom edge of the channel. The slot, which allows the round ladder rung to enter into and engage in the lock, was 1.5 inch wide. The brace, 14, was cut form aluminum flat stock in a triangle shape having a 24 inch base and 9 inches from base to peak. Two, 2 inch by 6 inch long, hand holds were cut on the two diagonal sides. The foot support was fabricated from two pieces of aluminum stair step material measuring 6 by 12 inches and having a TRACTION TREAD surface. The beam 12 was manufactured from 2 inch square aluminum tubing. It was 30 inches long. The various parts were welded together to form the ladder step accessory, 10, essentially as depicted in FIG. 1.

The above described embodiments of this invention are merely descriptive of its principles and are not to be limiting. The scope of this invention instead shall be determined from the scope of the following claims, including their equivalents.

Although the disclosure hereof is detailed and exact to enable those skilled in the art to practice the invention, the physical embodiments herein disclosed merely exemplify the invention which may be embodied in other specific structure. While the preferred embodiment has been described, the details may be changed without departing from the invention, which is defined by the claims.

What is claimed is:

1. A device to be supported by a roof ladder comprising:
a support beam having two ends;
a rung engaging ladder rail box secured to one of said ends, said box having at least two engaging means for engaging a ladder rail and two rungs of said ladder;
a foot support secured to the other end of said beam:
said beam securely supporting said rail box and said foot support;
whereby a firefighter may place his foot on the foot support or beam to steady himself as he ventilates the roof of a burning building.

2. The device of claim 1, further comprising:
said angularly related surfaces joining at an angle of about 90°;
said ladder rail box being capable of fitting over a plurality of different sizes of side rails of said ladders;
whereby said device may be used on a wide variety of ladders.

3. The device of claim 1 wherein said ladder rung engaging means comprises two bi-hooks formed in a side of said rail engaging means for engaging two adjacent ladder rungs, while straddling either the left or right ladder rail and the beam and foot support project essentially perpendicularly out from said ladder.

4. The device of claim 2 wherein said bi-hooks are located in the side of said ladder rail box at a height that permits the beam to lie flat on the surface of a roof.
